(19) United States
(12) Patent Application Publication
(10) Pub. No.: US 2012/0048437 A1
(43) Pub. Date: Mar. 1, 2012

(54) RUBBER COMPOSITION FOR TIRE, PRODUCTION METHOD THEREOF, AND STUDLESS TIRE

(76) Inventor: Ryoji KOJIMA, Kobe-shi (JP)

(21) Appl. No.: 13/215,329

(22) Filed: Aug. 23, 2011

(30) Foreign Application Priority Data
Aug. 24, 2010 (JP) 2010-187448

(51) Int. Cl. B60C 11/00; C08L 9/00; C08L 7/00

(52) U.S. Cl. 152/209.1; 524/526

(57) ABSTRACT

The present invention aims to provide a rubber composition for a tire which can improve the performance on snow and ice, abrasion resistance and tensile strength in a well-balanced manner. The present invention also aims to provide a method for producing the rubber composition and a studless tire having a cap tread produced from the rubber composition. The rubber composition for a tire is obtainable by mixing a rubber component containing natural rubber and butadiene rubber with silica at a temperature of 70 to 130° C. to form a mixture, and keeping the mixture at a temperature of 150 to 200° C.

### TECHNICAL FIELD

The present invention relates to a rubber composition for a tire, a production method thereof, and a studless tire (winter tire) having a cap tread produced from the rubber composition.

### BACKGROUND ART

Vehicles have been equipped with spike tires or chained tires for driving ice and snow covered roads. This, however, causes environmental problems such as dust pollution, and studless tires have been developed as a replacement for the spike tires and chained tires for driving ice and snow covered roads. Studless tires have been improved in their materials and designs to increase grip performance on ice and snow covered roads. For example, studless tires are designed to have deeper grooves than regular tires in order to increase irregularities of the surface facing the road. In addition, studless tires contain butadiene rubber with a low glass transition temperature in order to increase flexibility at low temperatures. Generally, natural rubber is contained as well because use of butadiene rubber alone cannot maintain sufficient abrasion resistance and tensile strength required for studless tires in some cases.

In recent years, in place of conventionally used carbon black, silica having excellent low temperature properties is becoming predominantly used as a filler to further improve the performance on snow and ice. Addition of silica requires mixing a rubber component, silica and a silane coupling agent at a high temperature (approximately 150° C.) to react these components with one another. However, in the case of a long-time mixing at high temperatures, the polymers (rubber component) tend to be damaged, leading to deterioration of abrasion resistance and tensile strength. That is, addition of silica improves the performance on snow and ice, but tends to result in damage to the polymers. Therefore, even if natural rubber is added, its excellent abrasion resistance and tensile strength may unfortunately deteriorate. Accordingly, a method for improving the performance on snow and ice, abrasion resistance, and tensile strength in a well-balanced manner has been desired.

Patent Document 1 discloses a technique to increase the reactivity of silica and a silane coupling agent by mixing a rubber component, silica and a silane coupling agent with an internal rubber mixer, and then mixing the resulting mixture with a two-roll kneader while controlling the temperature at 120 to 200° C. However, further improvement is still required to achieve a well-balanced enhancement of the performance on snow and ice, abrasion resistance and tensile strength.
Patent Document 1: JP 2010-89423 A

### SUMMARY OF THE INVENTION

The present invention aims to solve the foregoing problems and to provide a rubber composition for a tire which can improve the performance on snow and ice, abrasion resistance and tensile strength in a well-balanced manner, and also aims to provide a method for producing the rubber composition, and a studless tire having a cap tread produced from the rubber composition.

The present invention relates to a rubber composition for a tire obtainable by mixing a rubber component containing natural rubber and butadiene rubber with silica at a temperature of 70 to 130° C. to form a mixture, and keeping the mixture at a temperature of 150 to 200° C.

Preferably, the total amount of the natural rubber and the butadiene rubber is 30 to 100% by mass based on 100% by mass of the rubber component, and the amount of the silica is 10 to 80 parts by mass relative to 100 parts by mass of the rubber component.

The present invention also relates to a method for producing a rubber composition for a tire, including the steps of: (I) mixing a rubber component containing natural rubber and butadiene rubber with silica at a temperature of 70 to 130° C. to form a mixture; and (II) keeping the mixture of the step (I) at a temperature of 150 to 200° C.

The present invention further relates to a studless tire having a cap tread produced from the rubber composition.

The rubber composition for a tire of the present invention is obtainable by mixing a rubber component containing natural rubber and butadiene rubber with silica at low temperatures to form a mixture, and keeping the mixture at high temperatures.

Thus, the rubber composition can improve the performance on snow and ice, abrasion resistance and tensile strength in a well-balanced manner. Accordingly, use of the rubber composition for a tire component such as a cap tread can provide a studless tire excellent in these performances.

### BEST MODE FOR CARRYING OUT THE INVENTION

### <Rubber Composition>

The rubber composition of the present invention is obtainable by mixing a rubber component containing natural rubber and butadiene rubber with silica at a temperature of 70 to 130° C. to form a mixture, and keeping the mixture at a temperature of 150 to 200° C. In the case of mixing the rubber component and silica at such low temperatures as mentioned earlier, on one hand, it is possible to disperse silica while preventing damage to the polymers. On the other hand, a silane coupling agent becomes less reactive, and thus mixing needs to be performed for a longer period of time. However, if mixing is performed for a very long time, the polymers are more likely to be damaged, which diminishes the benefits of mixing at low temperatures. In contrast, according to the present invention, the mixture obtained by mixing at low temperatures is then kept at such high temperatures as mentioned earlier so that the reaction of a silane coupling agent can be accelerated, thereby preventing the polymers from being damaged by mixing for a long time. Thus, the performance on snow and ice can be improved by silica without deteriorating the excellent abrasion resistance and tensile strength of natural rubber, and these performances can be achieved in a well-balanced manner.

The rubber composition of the present invention can be preferably obtained, for example, by a production method including the steps of: (I) mixing a rubber component containing natural rubber and butadiene rubber with silica at a temperature of 70 to 130° C. to form a mixture; and (II) keeping the mixture of the step (I) at a temperature of 150 to 200° C.

### (Step (I))

In the step (I), a rubber component containing natural rubber and butadiene rubber is mixed with silica at low temperatures. The mixing method is not particularly limited as long as the components are mixed under controlled temperature conditions. For example, an internal kneader such as a Banbury mixer may be suitably used.

The mixing temperature in the step (I) is 70° C. or more, preferably 75° C. or more, and more preferably 80° C. or more. If the mixing temperature is less than 70° C., some chemical agents do not melt sufficiently. In addition, since the temperature of the polymers is low, the dispersion of silica and the reaction of a silane coupling agent may be insufficient. The mixing temperature is 130° C. or less, preferably 125° C. or less, and more preferably 120° C. or less. If the mixing temperature is more than 130° C., the polymers are more likely to be damaged during the mixing, and thus the tensile strength and abrasion resistance tend to deteriorate.

The time period for mixing in the step (I) is preferably about 1.5 times longer than the time period required for mixing at a usual mixing temperature (approximately 150° C.) Specifically, the time period for mixing is preferably 100 seconds or more, more preferably 110 seconds or more, and further preferably 120 seconds or more. In the case of less than 100 seconds, some chemical agents may not be sufficiently dispersed. The time period for mixing is preferably 200 seconds or less, more preferably 190 seconds or less, and further preferably 170 seconds or less. In the case of more than 200 seconds, although the chemical agents are sufficiently dispersed, the polymers are more likely to be damaged during the mixing, and thus the tensile strength and abrasion resistance tend to deteriorate.

The rubber component used in the step (I) includes natural rubber (NR) and butadiene rubber (BR). The NR and BR are not particularly limited, and those generally used in the tire industry may be used.

In the rubber composition of the present invention obtainable, for example, by the aforementioned production method, the NR content in 100% by mass of the rubber component is preferably 30% by mass or more, more preferably 40% by mass or more, and further preferably 50% by mass or more. In the case of less than 30% by mass, sufficient tensile strength and abrasion resistance may not be achieved. The NR content is preferably 90% by mass or less, more preferably 80% by mass or less, and further preferably 70% by mass or less. In the case of more than 90% by mass, the relative BR content is small, and thus sufficient performance on snow and ice may not be obtained.

In the rubber composition of the present invention obtainable, for example, by the aforementioned production method, the BR content in 100% by mass of the rubber component is preferably 10% by mass or more, more preferably 20% by mass or more, and further preferably 30% by mass or more. In the case of less than 10% by mass, sufficient performance on snow and ice may not be obtained. The BR content is preferably 70% by mass or less, more preferably 60% by mass or less, and further preferably 50% by mass or less. In the case of more than 70% by mass, the relative NR content is small, and thus sufficient tensile strength and abrasion resistance may not be obtained.

In the rubber composition of the present invention obtainable, for example, by the aforementioned production method, the total amount of the NR and the BR is preferably 30% by mass or more, more preferably 60% by mass or more, further preferably 80% by mass or more, and particularly preferably 100% by mass, based on 100% by mass of the rubber component. The larger the total amount is, the better the low temperature properties are, and thus necessary performance on snow and ice can be achieved.

The rubber composition of the present invention may contain diene rubbers such as modified natural rubber, isoprene rubber, and styrene-butadiene rubber, in addition to NR and BR.

The silica used in the step (I) is not particularly limited, and those generally used in the tire industry such as dry silica (anhydrous silica) and wet silica (hydrated silica) may be used.

The nitrogen adsorption specific surface area (N₂SA) of the silica is preferably 70 m²/g or more, and more preferably 140 m²/g or more. If the N₂SA is less than 70 m²/g, sufficient reinforcement cannot be obtained, and thus the tensile strength and abrasion resistance tend to deteriorate. The N₂SA of the silica is preferably 220 m²/g or less, and more preferably 200 m²/g or less. If the N₂SA is more than 220 m²/g, the silica is less likely to be dispersed, and thus the processability tends to deteriorate.

The N₂SA of the silica is a value measured by the BET method according to ASTM D3037-81.

In the rubber composition of the present invention obtainable, for example, by the aforementioned production method, the amount of the silica is preferably 10 parts by mass or more, and more preferably 20 parts by mass or more, relative to 100 parts by mass of the rubber component. If the amount of the silica is less than 10 parts by mass, the effects of silica addition may not be sufficiently obtained. The amount of the silica is preferably 80 parts by mass or less, and more preferably 50 parts by mass or less, relative to 100 parts by mass of the rubber component. If the amount of the silica is more than 80 parts by mass, the silica is less likely to be dispersed, and thus the processability tends to deteriorate.

In the step (I), a silane coupling agent is preferably mixed together with the rubber component and silica.

As the silane coupling agent, any silane coupling agent conventionally used with silica in the rubber industry may be used, and examples thereof include sulfide-type silane coupling agents such as bis(3-triethoxysilylpropyl)disulfide; mercapto-type silane coupling agents such as 3-mercaptopropyltrimethoxysilane; vinyl-type silane coupling agents such as vinyltriethoxysilane; amino-type silane coupling agents such as 3-aminopropyltriethoxysilane; glycidoxy-type silane coupling agents such as γ-glycidoxypropyltriethoxysilane; nitro-type silane coupling agents such as 3-nitropropyltrimethoxysilane; and chloro-type silane coupling agents such as 3-chloropropyltrimethoxysilane. Among the examples, sulfide-type silane coupling agents are preferable and bis(3-triethoxysilylpropyl)disulfide is more preferable because of their good reactivity with silica.

In the rubber composition of the present invention obtainable, for example, by the aforementioned production method, the amount of the silane coupling agent is preferably 3 parts by mass or more, and more preferably 6 parts by mass or more, relative to 100 parts by mass of the silica. If the amount is less than 3 parts by mass, the tensile strength tends to deteriorate. The amount of the silane coupling agent is preferably 12 parts by mass or less, and more preferably 10 parts by mass or less, relative to 100 parts by mass of the silica. If the amount is more than 12 parts by mass, the effects appropriate for the cost increase tend not to be obtained.

### (Step (II))

In the step (II), the mixture obtained in the step (I) is kept (stood still) at high temperatures. The keeping method is not particularly limited as long as the temperature is controlled, and for example a thermostatic system such as an oven may be suitably used. Alternatively, the mixture may be kept at high temperatures in a kneader used in the step (I).

The keeping temperature in the step (II) is 150° C. or more, preferably 160° C. or more, and more preferably 180° C. or more. If the keeping temperature is less than 150° C., the silica and the silane coupling agent may not sufficiently react with each other. The keeping temperature is 200° C. or less, preferably 190° C. or less, and more preferably 180° C. or less. If the keeping temperature exceeds 200° C., the silica and the silane coupling agent may react excessively. As a result, the rubber composition may form a gel, and thus molding may be difficult.

The time period for keeping in the step (II) is preferably 55 seconds or more, more preferably 100 seconds or more, further preferably 110 seconds or more, and particularly preferably 120 seconds or more. If the time period is less than 55 seconds, the silica and the silane coupling agent may not sufficiently react with each other. The upper limit of the time period for keeping is not particularly limited; however, a time period of 300 seconds or less is preferable because no performance improvement is obtained after 300 seconds.

After the step (II), materials such as sulfur and a vulcanization accelerator are further added and mixed, followed by vulcanization, according to a known method. Thus, a rubber composition of the present invention can be obtained.

The rubber composition of the present invention may optionally contain various materials generally used in the tire industry, such as carbon black, zinc oxide, stearic acid and an antioxidant, in addition to the aforementioned materials.

These materials may be mixed in the step (I) or may be mixed in a separate step.

The rubber composition of the present invention may be used for various tire components, and in particular may be suitably used for a cap tread.

The studless tire of the present invention can be produced using the rubber composition by a usual method. More specifically, the unvulcanized rubber composition containing additives as needed is extruded and processed into a cap tread shape, and then molded with other tire components by a common method on a tire building machine to form an unvulcanized tire. Thereafter, the unvulcanized tire is heated and pressurized in a vulcanizer so that a studless tire is produced.

### EXAMPLES

The present invention will be specifically described below based on Examples; however, the present invention is not limited to the Examples.

The chemical agents used in examples are listed below.

### NR: RSS#3

BR: BR150B (cis-1,4 bond content: 97% by mass, ML₁₊₄ (100° C.) 40, viscosity of 5% solution in toluene at 25° C.: 48, Mw/Mn: 3.3) produced by Ube Industries, Ltd.
Carbon Black: SHOBLACK N220 (N₂SA: 111 m²/g) produced by Cabot Japan K.K.

Silica: Ultrasil VN3 (N₂SA: 175 m²/g) produced by Degussa AG

Silane coupling agent: Si266 (bis(3-triethoxysilylpropyl)disulfide) produced by Degussa AG
Mineral oil: PS-32 produced by Idemitsu Kosan Co., Ltd.
Stearic acid: Kiri produced by NOF Corporation
Zinc oxide: Zinc oxide #2 produced by Mitsui Mining & Smelting Co., Ltd.
Antioxidant: NOCRAC 6C produced by Ouchi Shinko Chemical Industrial Co., Ltd.
Wax: OZOACE wax produced by Nippon Seiro Co., Ltd.
Sulfur: Sulfur powder produced by Tsurumi Chemical Industry Co., Ltd
Vulcanization accelerator NS: NOCCELER NS produced by Ouchi Shinko Chemical Industrial Co., Ltd.
Vulcanization accelerator DPG: NOCCELER D produced by Ouchi Shinko Chemical Industrial Co., Ltd.

### Examples 1 to 6 and Comparative Examples 1 to 5

The chemical agents in the formulation amounts shown in Step (I) of Table 1 were charged and mixed in a Banbury mixer.

In this step, the mixing temperature and time period were changed on each example. Next, the mixture obtained in the step (I) was placed in an oven set at each predetermined temperature and left for each predetermined time period (step (II)). To the mixture taken out from the oven were then added the sulfur and vulcanization accelerators in the formulation amounts shown in Step (III) of Table 1, and the resulting mixture was mixed with an open roll mill for 3 minutes at about 80° C. to obtain an unvulcanized rubber composition. In Comparative Example 1, the step (II) was skipped so that the mixture obtained in the step (I) was directly subjected to Step (III).

The thus obtained unvulcanized rubber composition was press-vulcanized for 12 minutes at 170° C. to prepare a vulcanized rubber composition.

Also, the thus obtained unvulcanized rubber composition was molded into a tread shape, and assembled with other tire components, followed by vulcanization for 15 minutes at 170° C. Thus, studless tires (tire size: 195/65R15) of Examples and Comparative Examples were produced.

The vulcanized rubber compositions and the studless tires were evaluated for the following performances. Table 1 shows the results.

### (1) Hardness

In accordance with JIS K6253, the hardness of the vulcanized rubber compositions was determined at −10° C. by a type A durometer. Based on the following equation, the determined value of each formulation was expressed as an index relative to the value of Comparative Example 1 regarded as 100.

(Hardness index)=(Hardness of each formulation)/(Hardness of Comparative Example 1)×100

### (2) Tensile Test

A No. 3 dumbbell specimen was prepared by punching out a specimen having a thickness of 2 mm from the vulcanized rubber composition of each formulation, and was subjected to a tensile test in accordance with JIS K6251 “Rubber, vulcanized or thermoplastic—Determination of tensile stress-strain properties” so that the tensile strength (TB) of the specimen was determined. Based on the following equation, the determined value of each formulation was expressed as an index relative to the value of Comparative Example 1 regarded as 100. The larger the index is, the higher the tensile strength is.

(Tensile strength index)=(TB of each formulation)/(TB of Comparative Example 1)×100

### (3) Performance on Snow and Ice

Each set of studless tires was mounted on a 2000-cc FR car made in Japan, and the distance (brake stopping distance) required for the car to stop after the brakes that lock up were applied at 30 km/h was measured. The test was run on a test course in Nayoro, Hokkaido, Japan. The temperature at the time of measuring was −6° C. to −1° C. Based on the following equation, the determined value of each formulation was expressed as an index relative to the value of Comparative Example 1 regarded as 100. The larger the index is, the better the performance on snow and ice is.

(Index of performance on snow and ice)=(Brake stopping distance of Comparative Example 1)/(Brake stopping distance of each formulation)×100

### (4) Abrasion Resistance

Each set of studless tires was mounted on a 2000-cc FR car made in Japan, and the depth of grooves on the tire tread was measured after the car had run 8000 km. The running distance that decreased the depth of grooves by 1 mm was calculated. Based on the following equation, the determined value of each formulation was expressed as an index relative to the value of Comparative Example 1 regarded as 100. The larger the index is, the better the abrasion resistance is.

(Abrasion resistance index)=(Running distance of each formulation)/(Running distance of Comparative Example 1)×100

TABLE 1

| | | | Examples | | | | | | Comparative Examples | | | | |
|---|---|---|---|---|---|---|---|---|---|---|---|---|---|
| | | | 1 | 2 | 3 | 4 | 5 | 6 | 1 | 2 | 3 | 4 | 5 |
| Step I | Formulation | NR | 60 | 60 | 60 | 60 | 60 | 60 | 60 | 60 | 60 | 60 | 60 |
| | (part(s) by mass) | BR | 40 | 40 | 40 | 40 | 40 | 40 | 40 | 40 | 40 | 40 | 40 |
| | | Carbon black | 20 | 20 | 20 | 20 | 20 | 20 | 20 | 20 | 20 | 20 | 20 |
| | | Silica | 30 | 30 | 30 | 30 | 30 | 30 | 30 | 30 | 30 | 30 | 30 |
| | | Silane coupling | 2.4 | 2.4 | 2.4 | 2.4 | 2.4 | 2.4 | 2.4 | 2.4 | 2.4 | 2.4 | 2.4 |
| | | agent | | | | | | | | | | | |
| | | Mineral oil | 20 | 20 | 20 | 20 | 20 | 20 | 20 | 20 | 20 | 20 | 20 |
| | | Stearic acid | 2 | 2 | 2 | 2 | 2 | 2 | 2 | 2 | 2 | 2 | 2 |
| | | Zinc oxide | 3 | 3 | 3 | 3 | 3 | 3 | 3 | 3 | 3 | 3 | 3 |
| | | Antioxidant | 2 | 2 | 2 | 2 | 2 | 2 | 2 | 2 | 2 | 2 | 2 |
| | | Wax | 2 | 2 | 2 | 2 | 2 | 2 | 2 | 2 | 2 | 2 | 2 |
| | Mixing temperature (° C.) | | 80 | 120 | 80 | 80 | 80 | 80 | 140 | 60 | 140 | 80 | 80 |
| | Time period for mixing | | 120 | 120 | 180 | 120 | 120 | 120 | 90 | 120 | 120 | 120 | 120 |
| | (seconds) | | | | | | | | | | | | |
| Step II | Keeping temperature (° C.) | | 170 | 170 | 170 | 200 | 170 | 170 | — | 170 | 170 | 130 | 220 |
| | Time period for keeping | | 120 | 120 | 120 | 120 | 300 | 60 | — | 120 | 120 | 120 | 120 |
| | (seconds) | | | | | | | | | | | | |
| Step III | Formulation | Sulfur | | | | | | | | | | | |
| | (part(s) by mass) | Vulucanization | 1.5 | 1.5 | 1.5 | 1.5 | 1.5 | 1.5 | 1.5 | 1.5 | 1.5 | 1.5 | 1.5 |
| | | accelerator NS | 1.5 | 1.5 | 1.5 | 1.5 | 1.5 | 1.5 | 1.5 | 1.5 | 1.5 | 1.5 | 1.5 |
| | | Vulucanization | 1 | 1 | 1 | 1 | 1 | 1 | 1 | 1 | 1 | 1 | 1 |
| | | accelerator DPG | | | | | | | | | | | |

| | | | | | | | | | | | | |
|---|---|---|---|---|---|---|---|---|---|---|---|---|
| Evaluation | Hardness index (−10° C.) | 100 | 99 | 99 | 100 | 100 | 100 | 100 | 108 | 100 | 100 | Gel |
| | Tensile strength index | 120 | 119 | 119 | 120 | 120 | 120 | 100 | 85 | 95 | 105 | formed |
| | Index of performance on | 110 | 110 | 110 | 112 | 112 | 100 | 100 | 90 | 110 | 92 | |
| | snow and ice | | | | | | | | | | | |
| | Abrasion resistance index | 110 | 109 | 109 | 110 | 110 | 100 | 100 | 80 | 95 | 98 | |

Table 1 indicates that the performance on snow and ice, abrasion resistance and tensile strength were improved in a well-balanced manner in Examples in which the mixing temperature in the step (I) was low, and the resulting mixture was kept at high temperatures after the step (I), as compared with Comparative Example 1. In addition, the hardness at a low temperature of Examples was similar to that of Comparative Example 1.

1. A rubber composition for a tire obtainable by
mixing a rubber component containing natural rubber and butadiene rubber with silica at a temperature of 70 to 130° C. to form a mixture, and
keeping the mixture at a temperature of 150 to 200° C.

2. The rubber composition according to claim 1, wherein the total amount of the natural rubber and the butadiene rubber is 30 to 100% by mass based on 100% by mass of the rubber component, and
the amount of the silica is 10 to 80 parts by mass relative to 100 parts by mass of the rubber component.

3. A method for producing the rubber composition according to claim 1, comprising the steps of:
(I) mixing a rubber component containing natural rubber and butadiene rubber with silica at a temperature of 70 to 130° C. to form a mixture; and
(II) keeping the mixture of the step (I) at a temperature of 150 to 200° C.

4. A studless tire having a cap tread produced from the rubber composition according to claim 1 or 2.
